(19) United States
(12) Patent Application Publication
(10) Pub. No.: US 2009/0119898 A1
(43) Pub. Date: May 14, 2009

(54) Method of assembling the head of a stirling machine

(75) Inventor: John Stephen Williams, Bromsgrove (GB)

Correspondence Address: Ballard Spahr Andrews & Ingersoll, LLP, SUITE 1000, 999 PEACHTREE STREET, ATLANTA, GA, 30309-3915, US

(73) Assignee: MICROGEN ENERGY LIMITED, Berkshire (GB)

(21) Appl. No.: 11/989,561

(22) PCT Filed: Jul. 26, 2006
(86) PCT No.: PCT/GB2006/002782

§ 371 Date: Jan. 28, 2008

(30) Foreign Application Priority Data
Jul. 27, 2005 (GB) 0515472.9

(51) Int. Cl. B23P 11/00

(52) U.S. Cl. 29/428; 60/526

(57) ABSTRACT

A method of assembling the head of a Stirling machine. Two sets of fins are fixed within the head casing. At least one regenerator element is passed through a central opening in the fins and is located in place between the two sets of fins. The regenerator elements are made from compacted wire and decompress in situ.

The present invention relates to a method of assembling the head of a Stirling machine. The invention relates particularly to a Stirling engine, for example a linear free piston Stirling engine, but is equally applicable to other types of Stirling machines such as a Stirling motor or refrigerator.

A Stirling machine is known which has a head with an open cup shaped configuration which is closed at one end and open at the opposite end. This open opposite end is fixed to a lower portion of the casing to form the overall machine casing. A set of heater fins is initially brazed into the head towards the closed end and is positioned such that, in use, it will receive heat from a burner conducted through the wall of the casing. A regenerator ring is then pushed into place next to the heater fins. A set of cooler fins is then inserted into the casing below the regenerator rings and brazed in place. When the cooler fins are brazed in place, the regenerator is subjected to the elevated temperatures of the braze cycle. The regenerator is typically made up of a large number of very fine components, such as random wires, stacked meshes or a rolled mesh sheet. The high temperature of the braze cycle can cause damage to the regenerator's structure having a detrimental effect on the performance and life of the regenerator.

This problem could be solved by soldering the cooler fins in place as this can be carried out at a lower temperature. However, a soldered joint is less reliable than a brazed one and can potentially reduce the efficiency of heat transfer through the fins and also increase the manufacturing costs.

According to the present invention there is provided a method of assembling the head of a Stirling machine, the head comprising a casing which is closed at one end and open at the opposite end, the method comprising fixing a set of heater fins within the casing towards the closed end, fixing a set of cooler fins towards the open end, and passing at least one regenerator element through a central opening in the set of cooler fins and locating it in place between the two sets of fins.

By fixing the cooler fins in place before the regenerator is installed, any damage to the regenerator element during the fixing of the cooler fins is avoided. Thus, the manner in which the cooler fins are attached to the casing is not constrained by any temperature considerations dictated by the regenerator. This allows the use of a high temperature fixing, such as brazing or welding.

There may only be a single regenerator element, in which case the single element must be expandable to allow it to pass through the central opening in the set of cooler fins. Alternatively, there may be a plurality of elements which, when assembled together, form an annular regenerator ring. In the case of a plurality of elements, these do not need to be expandable to pass through the central opening in the set of cooler fins, but there may be advantages in them being expandable. In particular expandable elements can expand to fill entirely the desired space removing any voids. When a number of elements are used, adjacent elements can expand onto one another at adjacent faces thereby ensuring that there are no gaps between adjacent elements, and that the packing density at an interface is similar to the density of the regenerator itself.

The regenerator may have any known configuration, provided that this can either be formed in an expandable configuration, or be divided into a plurality of circumferential segments.

Preferably, however, the regenerator is made of compacted random wire. Such a regenerator is particularly suitable for the present invention as compacted wire regenerator elements can be manufactured in a compressed configuration and quickly installed in the engine so that they decompress in-situ.

The regenerator ring made of a plurality of elements may either be made of elements which are manufactured individually, or may be manufactured as a single ring which is then cut into discrete elements.

The regenerator may be formed of a single regenerator ring. However, preferably, there are a plurality of regenerator rings arranged axially end to end. If each ring is made of a plurality of elements, the interface between elements in one ring is preferably offset from the interface between elements of an adjacent ring. This ensures that, should there be a relatively easy flow path between adjacent elements in one ring, that this path is not aligned with a similar path in an adjacent ring.

Preferably, the regenerator is supported at each axial end by a support ring which also acts to filter out any regenerator particles that may break away from the structure during operation. These support rings may be fitted at the same time as the two sets of fins. Alternatively, in order to avoid damage of the support rings during the fixing of the fins, they may be installed after the two sets of fins. In this case, the support rings will either need to be segmented or expandable in order to pass through the cooler fins. The support rings may be installed separately from the regenerator element, or may be attached to a regenerator element prior to installation.

According to a second aspect of the present invention, there is provided a regenerator for the internal space in the head of a Stirling machine, the regenerator comprising a plurality of elements arranged to form a complete ring, wherein each of the elements is made of compacted random wire. This aspect of the invention also extends to a method of assembling the head of a Stirling machine, the head comprising a casing, the method comprising inserting a plurality of regenerator elements into the casing, each element being made of compacted random wire which decompresses in situ, such that the assembled elements decompress in situ and form an annular regenerator ring.

An example of a method in accordance with the present invention will now be described with reference to the accompanying drawings, in which:

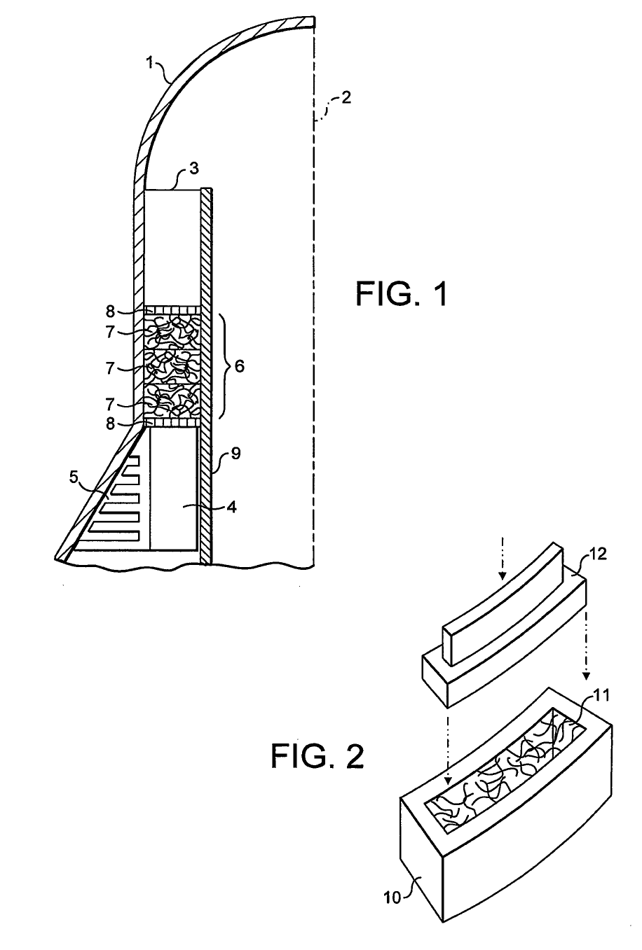

FIG. 1 is a cross-section through the left hand side of the casing at the engine head (right hand side corresponds);

FIG. 2 is a perspective view showing the manufacture of a regenerator element;

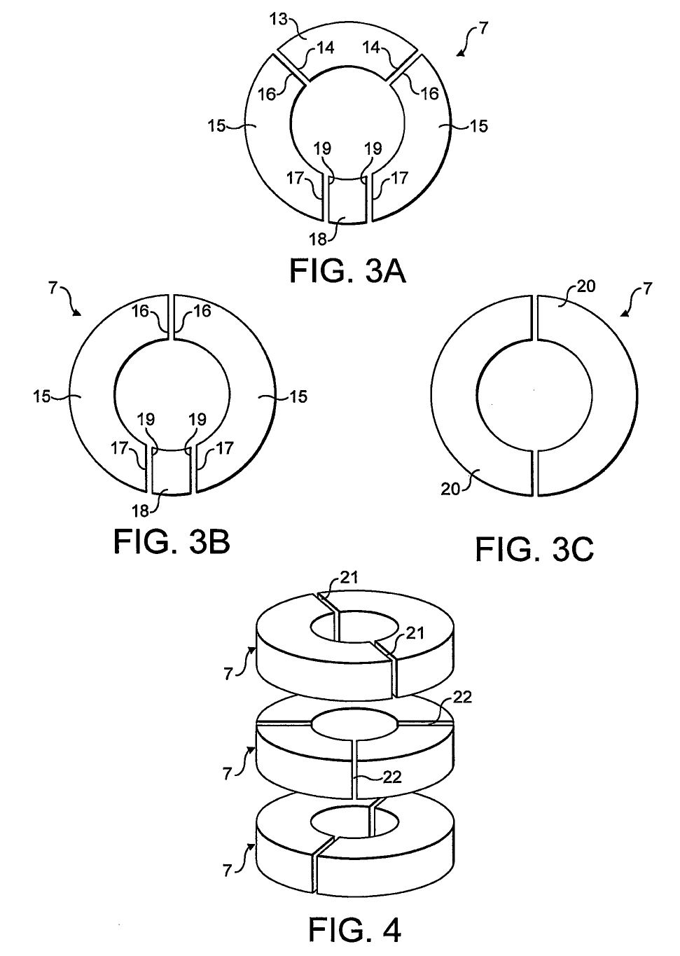

FIGS. 3A to 3B show, in plan, a number of regenerator ring configurations; and

FIG. 4 is an exploded perspective view of three regenerator rings.

A linear free piston Stirling engine is well known in the art, and will not be described in detail here.

The present invention relates only to the manner in which the casing for the engine head is assembled and this is shown in FIG. 1. The Stirling engine has a head casing 1 which is symmetrical about engine axis 2. The upper portion of the head has a closed dome shaped configuration, while the lower portion is open. In use, the head casing 1 will be permanently fixed, for example by welding or bolting to a lower engine casing (not shown) to form a sealed casing. An annular set of heating fins 3 are brazed into the casing 1 towards the closed end. These heater fins comprise a plurality of fins, each in a radial plane, the fins being arranged around the main axis 2. A similarly configured set of cooler fins 4 is brazed into the head casing 1 towards the open end, either at the same time as or subsequently to the brazing of the heater fins 3. A coolant channel 5 surrounds the cooler fins 4 to remove heat from these fins.

The regenerator 6 comprises three regenerator rings 7 arranged in the direction of axis 2. At each axial end of the regenerator 6 is an end plate 8 which is effectively a screen formed by a gauze washer. Once the regenerator rings 7 and support rings 8 are in position, a cylinder 9 in which a displacer (not shown) reciprocates is installed. If the cylinder 9 is not installed immediately after the regenerator, it may also be necessary to provide an inner sleeve with the same internal diameter as the fin internal dimension. A tapered insertion jig is then used to carefully push this up inside the cooler fins so that it locates between the two sets of fins and prevents the inward expansion of the regenerator which may interfere with the later insertion of the cylinder 9. As will be appreciated from FIG. 1, the regenerator 6 is bounded at its outermost surface by engine casing 1, at its innermost surface by cylinder 9 and at its top and bottom surfaces by support rings 8.

Each end plate 8 consists of a thin sintered ring closest to the regenerator and a gauze screen further from the regenerator to improve the filtering of random wire particles. There are two ways in which the these plates can be installed.

If the braze temperatures have minimal detrimental effects on the sintered rings, these could be placed into the centre of the regenerator space, as single piece components, before the fins are brazed in place and are held in position by a central expanding clamp. The gauze screens are flexible and resilient enough to be deformed and pushed through the central space within the cooler fins 4 after the brazing process and before the regenerator segments are installed. These screens are installed at the upper and lower ends of the regenerator space, springing back into their natural shape after insertion. The sintered rings are then pushed firmly upwards and downwards respectively into position, for example using an expanding screw jig as the rings are, by necessity, a tight fit within the annulus.

Alternatively, if the sintered rings are impaired by the brazing process, these could be segmented and inserted after the fins are in place. The rings are preferably cut into segments as opposed to being formed as separate segments as the sintered material is not resilient and there must be minimal clearance between the segments to avoid bypass flow. The gauze screens would then be deformed and inserted as described above.

The manner in which the regenerator is manufactured and assembled will now be described. The regenerator ring is shown as being made up of a plurality of segments. Where manufacturing tolerances can guarantee that the regenerator segments fit accurately against each other within the heater head with no spaces between to provide leakage paths for the through-flow, it is possible to use non-elastic regenerator segments. These can be manufactured either as separate segments or, to provide the accurate interfaces required, may be manufactured from a single element cut into segments.

FIG. 2 shows the manner in which a segment of a compacted random wire regenerator may be formed. A mould 10 with an arcuate cavity 11 is filled with random wires and compressed until a target volume is achieved (thereby giving a target porosity based on the mass of material used). The mould preferably has dimensions slightly smaller than the final dimensions of the cylinder as this will allow the segment to expand, in situ. A plunger 12 is then pressed into the cavity 11 with a predetermined load in order to compact the wires. In this manner, the regenerator may be manufactured in a compressed state which is arranged to decompress in-situ to fill the regenerator space.

If each regenerator ring 7 is manufactured as a single piece, the cavity 11 will be annular. Alternatively, an annular cavity may be used, and the resulting ring can be cut into a number of elements. In this case, the random wires could be sintered to provide a more coherent structure. However, a sintered structure is less compressible, so more segments would be required.

Various arrangements of regenerator elements are shown in FIGS. 3A to 3C.

FIG. 3A shows a regenerator ring 7 comprising four elements. The first element 13 has a radial end face 14. Two second elements 15 each have a radial end face 16 which abuts the respective radial face 14 of the first element 13. Each second element 15 has a second end face 17 configured so that, in-situ, the faces 17 are parallel. A third element 18 having parallel end faces 19 then provides an anchor element fitted between the end faces 17. In practice, each of the elements 13, 15, 18 is inserted into the head casing 1 through the cooler fins in the positions shown in FIG. 3A to make a complete ring with the third element being filled last. In FIG. 3A, the longest chord which can be drawn in any of the segments is smaller than the diameter of the opening within the cooler fins 4, so that each of the segments can, if necessary, be inserted in an uncompressed configuration.

FIG. 3B shows a similar configuration to FIG. 3A in which the first element 13 has been removed, such that the radial faces 16 of the second elements 15 abut one another. Depending upon the radial extent of the cooler fins 4, it may be that the second elements 15 need to be inserted in a compressed configuration to allow them to fit through the central opening in the set of cooler fins.

In FIG. 3C only two semi-annular regenerator elements 20 are provided. In this case, a considerable degree of compressibility is required in order to insert these elements.

It will be appreciated from FIGS. 3A to 3C that there is a trade off between the number of regenerator elements in a ring, and a requirement for compressibility. At one extreme, each ring may be formed of a single highly compressed element.

FIG. 4 shows the manner in which adjacent rings 7 may be arranged. From this it is apparent that interfaces 21 between elements in one ring are offset circumferentially from the interfaces 22 between elements in an adjacent set in order to prevent any easy bypass flow paths through the whole regenerator 6.

1. A method of assembling the head of a Stirling machine, the head comprising a casing which is closed at one end and open at the opposite end, the method comprising fixing a set of heater fins within the casing towards the closed end, fixing a set of cooler fins towards the open end, and passing at least one regenerator element through a central opening in the set of cooler fins and locating it in place between the two sets of fins.

2. A method according to claim 1, wherein the regenerator is formed of a plurality of elements which, when assembled together, form an annular regenerator ring.

3. A method according to claim 1, wherein the regenerator is inserted in a compressed configuration and decompresses in situ.

4. A method according to claim 2, wherein each of the elements is manufactured individually.

5. A method according to claim 2, wherein the elements are manufactured as a single ring which is then cut into discrete elements.

6. A method according to claim 1, wherein the regenerator is made of compacted random wire.

7. A method according to claim 6, wherein the random wire is sintered.

8. A method according to claim 2, wherein the regenerator is formed of a plurality of regenerator rings arranged axially end to end.

9. A method according to claim 8, wherein the interface between elements in one ring is offset from the interface between elements of an adjacent ring.

10. A method according to claim 1, wherein the regenerator is supported at each axial end by a support ring.

11. A method according to claim 10, wherein the support rings are installed after the two sets of fins.

12. A regenerator for the internal space in the head of a Stirling machine, the regenerator comprising a plurality of elements arranged to form a complete ring wherein each of the elements is made of compacted random wire.

13. A regenerator according to claim 12, wherein the elements are expanded in situ.

14. A regenerator according to claim 12, wherein the random wire is sintered.

15. A regenerator according to claim 12, formed of a plurality of regenerator rings arranged axially end to end.

16. A regenerator according to claim 15, wherein the interface between elements in one ring is offset from the interface between elements of an adjacent ring.

17. A regenerator according to claim 12 supported at each axial end by a support ring.

18. A Stirling engine having a regenerator according to claim 12.

19. A method of assembling the head of a Stirling machine, the head comprising a casing, the method comprising inserting a plurality of regenerator elements into the casing, each element being made of compacted random wire which decompresses in situ, such that the assembled elements decompress in situ and form an annular regenerator ring.

20. A method according to claim 1, wherein the regenerator is formed of a plurality of regenerator rings arranged axially end to end.
